(19) United States
(12) Patent Application Publication
(10) Pub. No.: US 2026/0167207 A1
(43) Pub. Date: Jun. 18, 2026

(54) AUTONOMOUS DRIVING METHOD FOR A VEHICLE, AND PROGRAM AND COMPUTER-READABLE RECORDING MEDIUM THEREFOR

(71) Applicants: HYUNDAI MOTOR COMPANY, Seoul (KR); KIA CORPORATION, Seoul (KR)

(72) Inventors: Jeong Kyu Kim, Hwaseong-si (KR); Se Young Lee, Hwaseong-si (KR); Sang Ho Shin, Hwaseong-si (KR)

(73) Assignees: HYUNDAI MOTOR COMPANY, Seoul (KR); KIA CORPORATION, Seoul (KR)

(21) Appl. No.: 19/362,110

(22) Filed: Oct. 17, 2025

(30) Foreign Application Priority Data
Dec. 13, 2024 (KR) 10-2024-0186229

(51) Int. Cl. B60W 50/00; B60W 50/14

(52) U.S. Cl. CPC B60W 50/0098; B60W 50/14; B60W 2050/0083; B60W 2050/146; B60W 2520/105; B60W 2540/18; B60W 2552/00; B60W 2554/406; B60W 2556/25

(57) ABSTRACT

An autonomous driving method for a vehicle includes checking operation setting of a forward collision-avoidance assist (FCA) function of the vehicle, collecting data for determining a sensitivity operation level of the FCA function, determining the sensitivity operation level of the FCA function from the data, and executing sensitivity operation level adjustment driving of the FCA function of the vehicle.

### CROSS-REFERENCE TO RELATED APPLICATIONS

This application claims the benefit of and priority to Korean Patent Application No. 10-2024-0186229, filed on Dec. 13, 2024, the entire contents of which are hereby incorporated by reference.

### BACKGROUND

### Field of the Disclosure

The present disclosure relates to an autonomous driving method for a vehicle.

### Discussion of the Related Art

An autonomous driving system has been applied to a recently released vehicle to provide safety for reducing traffic accidents, traffic efficiency on a road, environmental friendliness through fuel savings, and convenience.

Forward collision-avoidance assist (FCA) function in a vehicle recognizes an object, such as a vehicle, a pedestrian, or a cyclist, ahead of the vehicle. Upon determining that there is a risk of forward collision, the FCA function notifies a driver of the risk of collision through a warning message, a warning sound, etc, and performs a braking operation to avoid collision.

In general, a collision warning with respect to a vehicle or a motorcycle occurs when a host vehicle speed is about 10 to 200 km/h, and a collision warning with respect to a pedestrian or a bicycle occurs when the host vehicle speed is about 10 to 85 km/h.

The FCA function operates based on a time to collision (TTC), which is a time until collision set for each vehicle. Depending on the driving style of the driver or the driving environment of the vehicle, the driver may feel that a forward collision warning is too sensitive. The FCA function is a function for driving safety of the vehicle and has been conservatively developed to satisfy road traffic laws, and some drivers may feel that the FCA function of the vehicle operates too sensitively.

### SUMMARY

The present disclosure is directed to an autonomous driving method for a vehicle, a program, and a computer-readable recording medium that substantially obviate one or more problems due to limitations and disadvantages of the related art.

Embodiments of the present disclosure may adjust a sensitivity operation level by variably adjusting the TTC according to the driving style of the driver or the driving environment of the vehicle. In addition, in a situation where the FCA function continues to operate and the collision risk warning continues to sound, the risk of collision is high, and embodiments of the present disclosure may shorten a braking operation time of the vehicle and improve braking performance to increase safety.

Embodiments of the present disclosure provide a driving method for a vehicle that variably adjusts a TTC according to a driving style of a driver and a driving environment to adjust sensitivity operation level and improves braking performance to increase safety in an automobile in which an FCA function is executed.

Additional advantages, objects, and features of the present disclosure are set forth in part in the following description and in part should become more apparent to those having ordinary skill in the art upon examination of the following description or may be learned from practice of the present disclosure. The objectives and other advantages of the present disclosure may be realized and attained by the structure particularly pointed out in the written description and claims hereof as well as the appended drawings.

According to an aspect of the purpose of the present disclosure, an autonomous driving method for a vehicle is provided. The autonomous driving method includes checking operation setting of a forward collision-avoidance assist (FCA) function of the vehicle, collecting data for determining a sensitivity operation level of the FCA function, determining the sensitivity operation level of the FCA function from the data, and executing sensitivity operation level adjustment driving of the FCA function of the vehicle.

The autonomous driving method may further include executing additional safety performance improvement driving of the vehicle during execution of the sensitivity operation level adjustment driving of the FCA function of the vehicle.

Collecting data for determining a sensitivity operation level of the FCA function may include collecting data on a traffic congested section and a road condition, obtaining relative data with respect to front and side vehicles, and obtaining data on the vehicle being driven by a driver.

Determining the sensitivity operation level of the FCA function may include determining whether to activate sensitivity operation adjustment logic based on determining whether a value of Y is 1 or more under an OR condition for each piece of data of X1, X2, and X3, wherein Y is determined according to Y=(X1×k1)+(X2×k2)+(X3×k3), and wherein X1 denotes data collected from the traffic congested section and the road condition, X2 denotes relative data obtained for the front and side vehicles, and X3 denotes data obtained in the vehicle driven by the driver.

Relative data X2 may be obtained according to X2=(a×m1)+(b×m2)+(c×m3), wherein a represents a number of times that a forward vehicle reaches a distance criterion, b represents a number of times that a relative distance criterion with respect to an overtaken vehicle is reached, c represents a number of times that the forward vehicle reaches a TTC criterion, and each of m1, m2, and m3 is a constant.

X3 may be obtained according to X3=(d×n1)+(e×n2)+(f×n3)+(g×n4), wherein d represents a number of times that a longitudinal acceleration change criterion is reached, e represents a number of times that an APS change criterion is reached, f represents a number of times that a steering angle change amount criterion is reached, g represents whether a predetermined driving mode (ex. SPORT mode, SPORT+mode, etc.) is in effect, and n1, n2, n3, and n4 are constants.

Executing sensitivity operation level adjustment driving of the FCA function may include performing at least one of displaying a modal dialog indicating whether to operate FCA desensitization logic on a cluster of the vehicle, executing sensitive warning prevention and safety performance enhancement logic, or changing a braking pressure of an electronic stability controller (ESC).

Executing additional safety performance improvement driving of the vehicle may include at least one of performing additional safety performance improvement logic or changing a braking pressure of an electronic stability controller (ESC) (e.g., to 1.2 times a set braking pressure).

Determining the sensitivity operation level of the FCA function may further include determining whether to activate sensitivity operation adjustment logic, and correcting the collected data based on determining that the to activate sensitivity operation adjustment logic activation is in a failure mode.

In another aspect of the present disclosure, a program recorded on a computer-readable recording medium is provided. The program, when executed by one or more processors, causes the one or more processors to execute the autonomous driving method of the present disclosure.

In another aspect of the present disclosure, a computer-readable recording medium that stores the program is provided.

It should be understood that the foregoing general description and the following detailed description of the present disclosure are illustrative and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIGS. 1A and 1B are diagrams illustrating an autonomous driving method for a vehicle according to an embodiment of the present disclosure;

FIG. 2 is a block diagram illustrating that data for determining a sensitivity operation level of an FCA function is collected and the sensitivity operation level of the FCA function is determined based thereon;

FIG. 3 is a block diagram illustrating implementation of sensitivity operation level adjustment driving of the FCA function and implementation of additional safety performance improvement driving of the vehicle;

FIG. 4A illustrates TTC change analysis with respect to a forward vehicle;

FIG. 4B illustrates an example of analyzing longitudinal acceleration formation data through each of the number of times (twice) that longitudinal acceleration reaches a reference value (reference longitudinal acceleration); and

FIG. 4C illustrates an example of analyzing APS change amount data by counting the number of times that an APS change rate reaches a reference APS.

### DETAILED DESCRIPTION

Hereinafter, some embodiments of the present disclosure are described in detail with reference to illustrative drawings. When adding reference numerals to components in each drawing, it should be noted that identical components are given the same reference numerals as much as possible even when the components are shown in different drawings. In addition, when describing embodiments of the present disclosure, where it was determined that a specific description of a related known structure or function would hinder understanding of the embodiments of the present disclosure, the detailed description has been omitted.

In the description of the embodiments according to the present disclosure, when an element is described as being formed “on or under” another element, the two elements may be directly in contact with each other or may be indirectly formed with one or more other elements disposed therebetween. In addition, when the expression “on or under” is used, a direction thereof may include a downward direction as well as an upward direction based on one element.

In the present disclosure, when a component, controller, device, element, apparatus, unit or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, or the like may separately embody or be included with one or more processors and a memory, such as a non-transitory computer-readable media, as part of the apparatus.

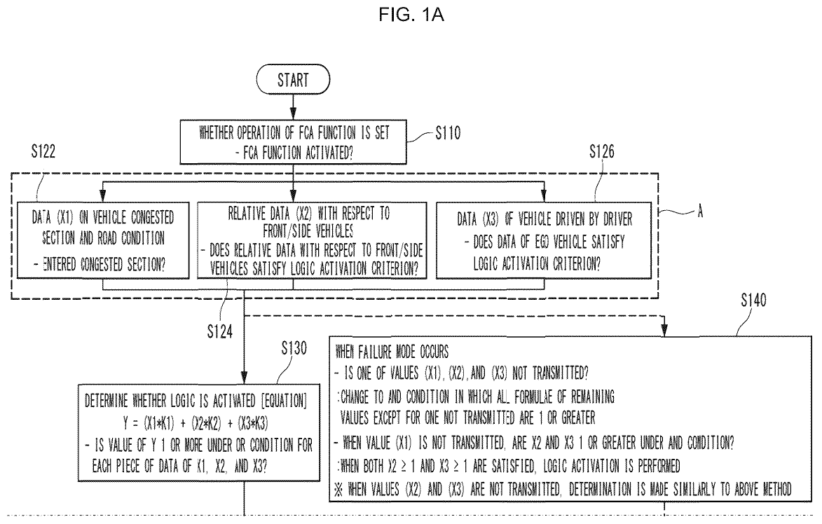

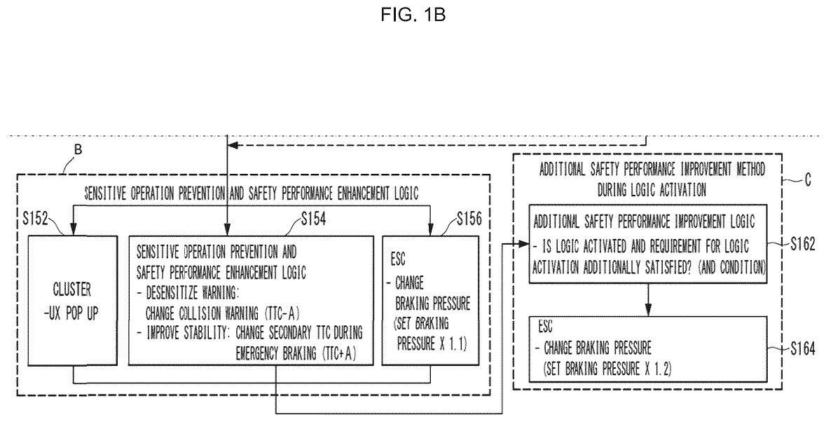

FIGS. 1A and 1B are diagrams illustrating an autonomous driving method for a vehicle according to an embodiment of the present disclosure.

Referring to FIGS. 1A and 1B, the autonomous driving method for the vehicle according to an embodiment may include: a step or operation S110 of checking operation setting of an FCA function of the vehicle; steps or operations S122, S124, and S126 of collecting data for determining a sensitivity operation level of the FCA function; a step or operation S130 of determining the sensitivity operation level of the FCA function from the collected data; and steps or operations S152, S154, and S156 of performing sensitivity operation level adjustment driving of the FCA function of the vehicle.

Details are described as follows.

In the step or operation S110, it is verified whether the FCA function is set to operate in the vehicle. For example, it is determined whether the FCA function is activated in the vehicle. When the FCA function is not activated, normal driving is continued. Upon confirming that the FCA function is activated, a step or operation (A) of collecting data for determining a sensitivity operation level of the FCA function below is performed.

The step or operation (A) of collecting the data for determining the sensitivity operation level of the FCA function may include a step or operation S122 of collecting data on a traffic congested section and a road condition, a step or operation S124 of obtaining relative data with respect to front and side vehicles, and a step or operation S126 of obtaining data on a vehicle being driven by a driver.

In the step or operation S122 of collecting the data (X1) on the traffic congested section and the road condition, it is possible to determine whether a vehicle has entered the congested section. For example, by utilizing information from a navigation system installed in the vehicle, it is possible to determine a traffic flow in a section where the vehicle is currently being driven and whether the vehicle has entered a congested section where an accident has occurred.

Further, in the step or operation 124 of obtaining the relative data with respect to the front and side vehicles, it is possible to determine whether relative data (X2) with respect to the forward vehicle or the side vehicle accords with a logic activation criterion. In this instance, it is possible to utilize information collected from sensors such as the front camera and the front radar or a front/rear-side radar.

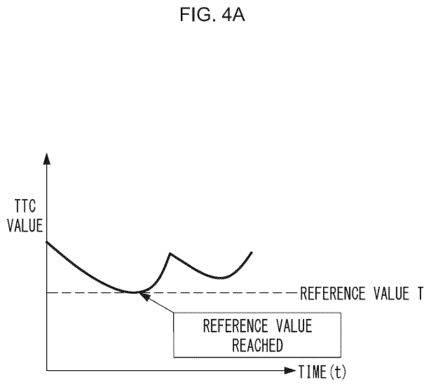

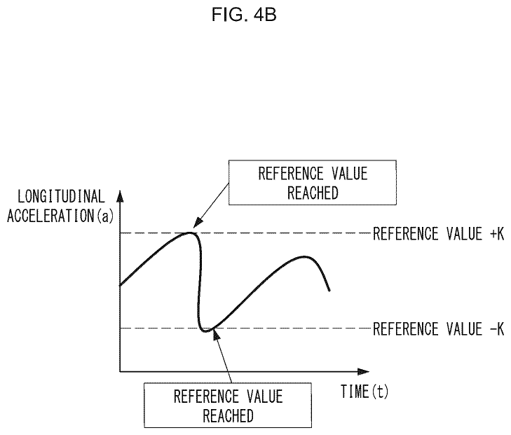

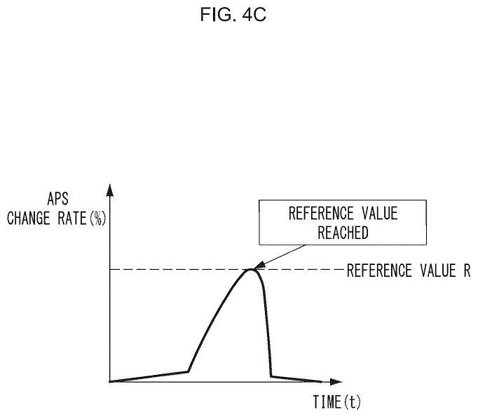

For example, it is possible to count a time for which a distance between the host vehicle with the driver on board and the forward vehicle is maintained within a reference distance to analyze a change in distance from the forward vehicle, analyze the number of times that a relative distance from an overtaken vehicle reaches within a reference distance at a point in time when changing lanes by overtaking the vehicle in an adjacent lane, i.e., the number of times that there is a risk of collision with the vehicle in the adjacent lane, or count the number of times that an expected TTC with respect to the forward vehicle reaches within a reference TTC to analyze a TTC change with respect to the forward vehicle. FIG. 4A illustrates TTC change analysis with respect to the forward vehicle where a reference value is reached once, according to an embodiment.

In addition, in the step or operation 126 of obtaining the data on the vehicle being driven by the driver, it is possible to determine whether data (X3) of the host vehicle in motion accords with the logic activation criterion. The data on the vehicle being driven by the driver may be obtained by utilizing, for example, Controller Area Network (CAN) data provided in the vehicle. Details are described as follows.

First, longitudinal acceleration formation data may be analyzed by counting the number of times that a value formed by longitudinal acceleration of the vehicle reaches reference longitudinal acceleration. Second, APS change amount data may be analyzed by counting the number of times that a vehicle Accelerator Position Sensor (APS) change rate reaches a reference APS. Third, steering angle change amount data may be analyzed by counting the number of times that a value formed by the steering angle change amount of the vehicle reaches a reference steering angle. Fourth, a driving mode setting value may be analyzed by verifying whether a driving mode setting value of the vehicle is a predetermined driving mode.

FIG. 4B illustrates an example of analyzing longitudinal acceleration formation data through each of the number of times (twice) that longitudinal acceleration reaches a reference value (reference longitudinal acceleration), according to an embodiment. FIG. 4C illustrates an example of analyzing APS change amount data by counting the number of times that an APS change rate reaches a reference APS, according to an embodiment.

Further, in the step or operation 130 of determining the sensitivity operation level of the FCA function from the collected data, it may be determined whether to activate sensitivity operation adjustment logic (e.g., sensitivity operation level adjustment and/or safety performance enhancement logic) according to Equation 1 below. In an example, the sensitivity operation adjustment logic may be determined to be activated when a value of Y is 1 or more under the OR condition for each piece of the data of X1, X2, and X3 collected above.

Y=(X1×k1)+(X2×k2)+(X3×k3) [Equation 1]

In Equation 1, k1, k2, and k3 may be constants, and X1, X2, and X3 may be data on the traffic congested section and the road condition, the relative data with respect to the front/side vehicles, and the data on the vehicle being driven by the driver, respectively, as described above.

A method of obtaining X1 to X3, according to an embodiment, is described as follows.

X1, which is the data on the vehicle congested section and the road condition, may be set to 0 when driving in a non-congested section on national roads and highways, and may be set to 1 when driving in a congested section on national roads and highways. In this instance, when driving in the congested section on national roads and highways, a possibility of sensitive warnings and collision risks may increase.

Sensitivity operation adjustment (e.g., sensitivity operation level adjustment and/or safety performance enhancement logic) may be activated when Y is 1 or more, and the sensitivity operation level adjustment and safety performance enhancement logic may be deactivated when Y is less than 1.

For example, when X1=1, X2=1.3, X3=1.8, k1=0.2, k2=0.4, and k3=0.2, then Y=(1×0.2)+(1.3×0.4)+(1.8×0.2)=1.08, and thus the sensitivity operation level adjustment and safety performance enhancement logic may be activated.

In this instance, X2 may be obtained from the following Equation 2.

X2=(a×m1)+(b×m2)+(c×m3) [Equation 2]

In Equation 2, a represents the number of times that the forward vehicle reaches a distance criterion, b represents the number of times that a relative distance criterion with respect to the overtaken vehicle is reached, c represents the number of times that the forward vehicle reaches a TTC criterion, and m1, m2, and m3 may each be a constant.

For example, when m1 to m3 are set to 0.1, 0.2, and 0.3 respectively, then X2=(a×0.1)+(b×0.2)+(c×0.3) may be satisfied.

Referring to a, which is the number of times that the forward vehicle reaches the distance criterion, when a distance value between a rear bumper of the forward vehicle and a front bumper of a driving vehicle approaches within a certain reference value, it is possible to determine that a possibility of a sensitive warning and a collision risk increase. In addition, the distance criterion may be set to, for example, 1.5 meters, and when the condition is satisfied, i.e., when the distance from the forward vehicle reaches within 1.5 meters, the value of a may be increased by +1.

In addition, referring to b, which is the number of times that the relative distance criterion is reached when a vehicle in an adjacent lane is overtaken, when a relative distance value with respect to the overtaken vehicle in the adjacent lane approaches within a certain reference value, it is possible to determine that a possibility of a sensitive warning and a collision risk increase. Further, the relative distance criterion may be set to 2.0 meters, and when the condition is satisfied, i.e., when the relative distance with respect to the overtaken vehicle reaches within 2.0 meters, the value of b may be increased by +1.

In addition, referring to c, which is the number of times that the forward vehicle reaches the TTC criterion, when a TTC value indicating a collision risk level with respect to the forward vehicle falls to a certain reference value or less, it is possible to determine that a possibility of a sensitive warning and a collision risk increase. Further, a TTC reference value with respect to the forward vehicle may be set to 2.5 seconds, and when the condition is satisfied, i.e., when the TTC with respect to the forward vehicle reaches within 2.5 seconds, the value of c may be increased by +1.

For example, when a=3, b=2, and c=2, then X2=(3x0.1)+(2×0.2)+(2×0.3)=1.3 may be satisfied.

In addition, X3 may be derived by synthesizing data of the driving vehicle of the driver using the following Equation 3.

X3=(d×n1)+(e×n2)+(f×n3)+(g×n4) [Equation 3]

In Equation 3, d represents the number of times that a longitudinal acceleration change criterion is reached, e represents the number of times that an APS change criterion is reached, f represents the number of times that a steering angle change amount criterion is reached, g represents whether the predetermined driving mode is in effect, and n1, n2, n3, and n4 may be constants.

X3, which is obtained by analyzing driving vehicle data of the driver, may be as follows. For example, when n1 to n4 are 0.2, 0.3, 0.3, and −1, respectively, X3=(d×0.2)+(e×0.3)+(f×0.3)+ (g×(−1)) may be satisfied.

Referring to d, which is the number of times that the longitudinal acceleration change criterion is reached, in a sudden acceleration or sudden braking situation when a longitudinal acceleration change value of the vehicle reaches certain reference value or more, it is possible to determine that a possibility of a sensitive warning and a collision risk increase.

For example, the longitudinal acceleration change criterion is set to ±9.8 m/s², and when the longitudinal acceleration change reaches±9.8 m/s², the value of d may increase by ±1.

In addition, referring to e, which is the number of times that the APS change criterion is reached, when an APS change value of the vehicle reaches a certain reference value or more, this means a sudden acceleration, and thus it is possible to determine that a possibility of a sensitive warning and a collision risk increase and to set the APS change criterion to 80%. When the condition is satisfied, i.e., when the APS change is 80% or more, the value of e may increase by ±1.

In addition, referring to f, which is the number of times that the steering angle change criterion is reached, when the steering angle of the vehicle reaches a certain reference value or more, this means a situation in which lanes are frequently changed, and thus it is possible to determine that a possibility of a sensitive warning and a collision risk increase. For example, the steering angle change criterion may be set to 60 deg/s, and when the steering angle change reaches 60 deg/s or more, the value of f may increase by ±1.

In addition, referring to g, which indicates whether the predetermined driving mode is in effect, when the driving mode of the vehicle is set to the predetermined driving, a possibility of sudden acceleration and sudden braking increases, and thus a criterion for the number of times of achievement may be increased. Specifically, the value of g may be set to 0.1 in the predetermined driving mode and set to 0 in other modes.

Referring to the value of X3, for example, when d=2, e=3, f=2, and g=1, then X3=(2×0.2)+(3×0.3)+(2×0.3)+ (0.1×−1)=1.8 may be satisfied.

In addition, upon determining from the collected data that the FCA function is operating too sensitively, e.g., upon determining from Equation 1 that the sensitivity operation adjustment logic is to be activated, the sensitivity operation level adjustment and/or safety performance enhancement logic is implemented (B).

In an example, corresponding content may be displayed on the cluster of the vehicle. For example, UX (User Experience) may be displayed in a step or operation S152 to guide whether FCA desensitization logic is operated. For example, it is possible to display a screen such as “Forward collision avoidance warning desensitization logic is activated. Drive safely.” in a modal dialog box.

Alternatively, it is possible to perform at least one of executing sensitive warning prevention and safety performance enhancement logic in a step or operation S154 or changing of braking pressure of an electronic stability controller (ESC) in a step or operation S156.

In this instance, when the sensitive warning prevention and safety performance enhancement logic is performed, a collision warning time may be changed to TTC-α to desensitize the warning, or a secondary TTC during emergency braking may be changed to TTC+α to improve stability. For example, when a is set to 0.05, a forward collision prevention warning TTC may be reduced to suppress a sensitivity operation level, or a TTC at a forward collision prevention control operation time may be increased to operate early, thereby increasing safety in the event of a collision risk. Accordingly, the TTC during collision warning may be reduced from, for example, 2.4 seconds to 2.35 seconds, or a secondary TTC during emergency braking may be increased from 1.2 seconds to 1.25 seconds.

Alternatively, the braking pressure of the ESC may be increased to enhance controllability of the vehicle, thereby further ensuring vehicle stability in a collision risk situation. The ESC braking pressure may be increased by z1 times the ESC set braking pressure, where z1 may be a constant. For example, when z1 is 1.1, the braking pressure of the ESC may be changed to 1.1 times the set braking pressure.

In addition, in a step or operation S130, when determining the sensitivity operation level of the FCA function from the collected data, if logic activation is a failure mode, a step or operation S140 of correcting the collected data may be further included.

In an example, in the above Equation 1, when the value of Y becomes less than 1 under the OR condition of each data of X1, X2, and X3, the sensitivity operation adjustment logic activation may be determined to be a failure mode, and correction may be performed as follows.

In an example, when one of the values X1, X2, and X3 is not transmitted, it is possible to change to an AND condition in which both formulae of the remaining two values except for the one not transmitted are 1 or greater. For example, when the value X1 is not transmitted, it is determined whether X2 and X3 are 1 or greater using the AND condition, and if the condition is satisfied, i.e., if X2≥1 and X3≥1, it is determined that the above condition is satisfied and sensitivity operation logic activation is performed.

In addition, in addition to executing the sensitivity operation level adjustment and safety performance enhancement logic (B) of the FCA function of the vehicle described above, additional safety performance improvement driving (C) of the vehicle may be implemented.

For example, additional safety performance improvement logic may be performed in a step or operation S162. In an example, when the logic determined by the existing Equation 1 is activated, in addition to Equation 1, it is verified whether the value of Y is 1 or greater under the AND condition of respective pieces of data.

In addition, or alternatively, the braking pressure of the ESC may be increased in a step or operation S164. For example, when a first warning for forward collision prevention occurs certain times or more, the ESC braking pressure may be additionally increased. In this instance, the ESC braking pressure may be increased by z2 times the ESC set braking pressure, where z2 may be a constant. For example, when z2 is 1.2, the ESC braking pressure may be changed to 1.2 times the set braking pressure.

The autonomous driving method for the vehicle of FIGS. 1A and 1B described above may initialize the entire logic when the vehicle in motion is turned off, in an embodiment.

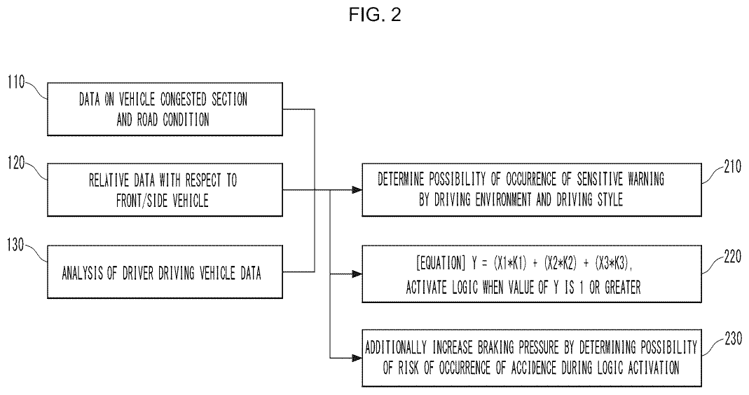

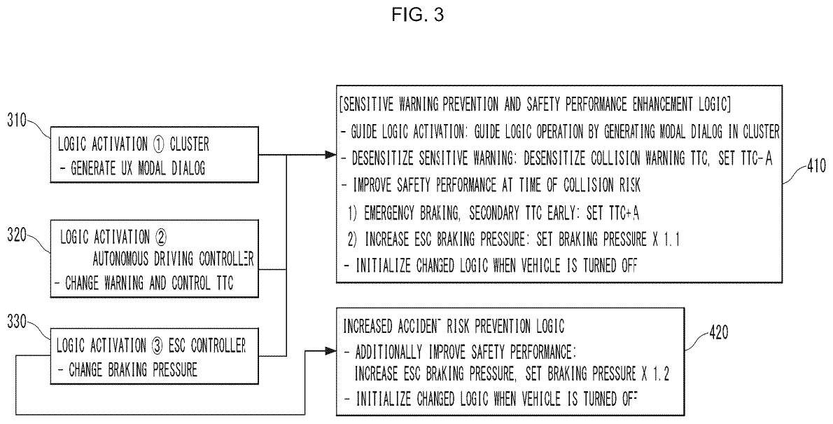

FIG. 2 is a block diagram illustrating that data for determining the sensitivity operation level of the FCA function is collected and the sensitivity operation level of the FCA function is determined based thereon, according to an embodiment. FIG. 3 is a block diagram illustrating implementation of sensitivity operation level adjustment driving of the FCA function and implementation of additional safety performance improvement driving of the vehicle, and illustrates that the autonomous driving method for the vehicle illustrated in FIGS. 1A and 1B is implemented, according to an embodiment.

In FIG. 2, X1 110, which is data on the vehicle congested section and the road condition, X2 120, which is relative data with respect to the front/side vehicle, and X3 130, which is obtained by analyzing driver driving vehicle data, are collected to determine a possibility of occurrence of a sensitive warning by a driving environment and a driving style in a step or operation 210. In the above-described equation (Equation 1), when the value of Y is 1 or greater, the sensitivity operation adjustment logic is activated in a step or operation 220 to perform sensitivity operation level adjustment driving of the FCA function of the vehicle. Upon determining that there is a high risk of occurrence of a collision accident of the vehicle during sensitivity operation adjustment logic activation, the braking pressure may be further increased in a step or operation 230.

Referring to FIG. 3, sensitivity operation adjustment logic activation may be performed by (1) displaying a UX modal dialog on the cluster in a step or operation 310, (2) changing a warning and control TTC in the autonomous driving controller in a step or operation 320, or (3) changing the braking pressure of the vehicle in the ESC controller in a step or operation 330.

Specifically, as illustrated in in a block 410, [sensitive warning prevention and safety performance enhancement logic] guides that the sensitivity operation adjustment logic is activated and operates when a modal dialog is displayed on the cluster, desensitizes the collision warning TTC by setting the TTC to TTC−α or increases the TTC at the time of control operation during emergency braking to, for example, the set TTC+α to operate early, or increases the ESC braking pressure to 1.1 times the set braking pressure to be able to improve stability performance at the time of collision risk.

In addition, as illustrated in a block 420, [increased accident risk prevention logic] further improves safety performance by increasing the ESC braking pressure to 1.2 times the set braking pressure, and may initialize the changed sensitivity operation adjustment logic when the vehicle is turned off.

Another embodiment of the present disclosure provides a program recorded on a computer-readable recording medium, wherein the autonomous driving method for the vehicle described above is executed by one or more processors.

Still another embodiment of the present disclosure provides a computer-readable recording medium storing the program described above.

The autonomous driving method for the vehicle according to embodiments of the present disclosure may be implemented in driving of the vehicle in which SCC is operated. A data analysis unit may determine the sensitivity operation level and increased risk according to the driving environment of the vehicle and the driving style of the driver based on data received from the camera and radar installed in the vehicle, a calculation unit may calculate the above-mentioned equations related to the logic, a controller may determine the above-described failure mode, and the controller may control operations of devices such as the above-described camera, radar, cluster, and ESC.

The autonomous driving method for the vehicle according to the present disclosure described above may improve customer satisfaction by preventing a sensitive warning operation that may occur depending on the driving environment and driving style of the driver during FCA control, and may increase safety in a situation where there is a high possibility of an accident.

In detail, various information is collected for determination so that the driving environment and driving style of the driver may be comprehensively determined. Whether the congested section is entered is determined based on data on the congested section and road condition of the vehicle, and the relative data with respect to the front/side vehicles and the data of the driving vehicle are synthesized. When a certain criterion is satisfied, the sensitivity operation adjustment logic is activated to reduce the collision warning TTC and suppress sensitive warnings. In a situation where warnings continuously occur, there is a high possibility of an accident, and thus the secondary TTC of the emergency braking is increased and safety performance is improved by increasing the ESC braking pressure, so that accidents may be prevented and damage may be reduced when an accident occurs.

In addition, since the logic makes a determination by synthesizing information that may be acquired through sensors previously installed in the vehicle and CAN data, it is possible to improve safety and suppress sensitive warnings simply by modifying software and/or firmware, and thus the vehicle manufacturing cost may not increase.

The autonomous driving method for the vehicle according to embodiments of the present disclosure may improve customer satisfaction by preventing a sensitive warning operation that may occur depending on the driving environment and driving style of the driver during FCA control, and may increase safety in a situation where there is a high possibility of an accident.

In the above description, even though all the components included in the embodiments of the present disclosure have been described as being combined into one or operating in combination, the present disclosure is not necessarily limited to these embodiments. For example, within the scope of the purpose of the present disclosure, all of the components may be selectively combined into one or more and operated. In addition, the terms “include”, “comprise”, or “have” described above, unless specifically stated to the contrary, mean that the corresponding components may be included, and therefore should be interpreted to include other components rather than excluding other components. All terms, including technical or scientific terms, unless defined otherwise, have the same meaning as commonly understood by a person of ordinary skill in the art to which the present disclosure pertains. Commonly used terms, such as terms defined: in dictionaries, should be interpreted as consistent with meanings thereof in the context of the relevant art, and should not be interpreted in an idealized or overly formal sense, unless explicitly defined in the present disclosure.

The above description is only an illustrative example of the technical idea of the present disclosure, and those having ordinary skill in the art to which the present disclosure pertains may make various modifications and variations without departing from the essential characteristics of the present disclosure. Accordingly, the embodiments described in the present disclosure are not intended to limit the technical idea of the present disclosure but to describe the technical idea, and the scope of the technical idea of the present disclosure is not limited by these embodiments. The scope of protection of the present disclosure should be interpreted by the claims below, and all technical ideas within a scope equivalent thereto should be interpreted as being included in the scope of rights of the present disclosure.

What is claimed is:

1. A method for autonomous driving or driving assist in a host vehicle, the method comprising:
checking one or more operation settings of a forward collision-avoidance assist (FCA) function of the host vehicle;
collecting data for determining a sensitivity operation level of the FCA function;
determining the sensitivity operation level of the FCA function based on the collected data; and
executing sensitivity operation level adjustment for the FCA function.

2. The method according to claim 1, further comprising executing an additional safety performance improvement driving of the host vehicle during execution of the sensitivity operation level adjustment.

3. The method according to claim 1, wherein collecting data for determining a sensitivity operation level of the FCA function includes:
collecting data on a traffic congested section and a road condition;
obtaining relative data with respect to front and side vehicles; and
obtaining data on the host vehicle being driven by a driver.

4. The method according to claim 3, wherein determining the sensitivity operation level of the FCA function includes determining whether to activate sensitivity operation adjustment logic based determining whether a value of Y is 1 or more under an OR condition for each piece of data of X1, X2, and X3, wherein Y is determined according to
Y=(X1×k1)+(X2×k2)+(X3×k3),
wherein X1 denotes data collected from the traffic congested section and the road condition, X2 denotes relative data obtained for the front and side vehicles, and X3 denotes data obtained in the host vehicle driven by the driver.

5. The method according to claim 4, wherein the relative data X2 is obtained according to
X2=(a×m1)+(b×m2)+(c×m3),
wherein a represents a number of times that a forward vehicle reaches a distance criterion, b represents a number of times that a relative distance criterion with respect to a side vehicle to overtake is reached, c represents a number of times that the forward vehicle reaches a TTC criterion, and each of m1, m2, and m3 is a constant.

6. The method according to claim 4, wherein X3 is obtained according to
X3=(d×n1)+(e×n2)+(f×n3)+(g×n4),
wherein d represents a number of times that a longitudinal acceleration change criterion is reached, e represents a number of times that an APS change criterion is reached, f represents a number of times that a steering angle change amount criterion is reached, g represents whether a predetermined driving mode is in effect, and n1, n2, n3, and n4 are constants.

7. The method according to claim 1, wherein executing the sensitivity operation level adjustment for the FCA function includes performing at least one of displaying a modal dialog indicating whether to FCA desensitization logic is operated on a of cluster the host vehicle, executing sensitive warning prevention and safety performance enhancement logic, or changing a braking pressure of an electronic stability controller (ESC).

8. The method according to claim 2, wherein executing the additional safety performance improvement driving of the vehicle includes at least one of performing additional safety performance improvement logic or changing a braking pressure of an electronic stability controller (ESC) to a predetermined braking pressure.

9. The method according to claim 1, wherein determining the sensitivity operation level of the FCA function includes:
determining whether to activate sensitivity operation adjustment logic; and
correcting the collected data based on determining that the sensitivity operation adjustment logic activation is in a failure mode.

10. A non-transitory computer-readable recording medium storing computer-readable instructions that, when executed by one or more processors, cause the one or more processors to:
check one or more operation settings of a forward collision-avoidance assist (FCA) function of a host vehicle;
collect data for determining a sensitivity operation level of the FCA function;
determine the sensitivity operation level of the FCA function based on the collected data; and
execute sensitivity operation level adjustment for the FCA function.

11. A vehicle controller comprising:
a non-transitory computer-readable recording medium storing computer-readable instructions; and
one or more processors configured to execute the computer-readable instructions,
wherein the computer-readable instructions, when executed by the one or more processors, cause the one or more processors to:
check one or more operation settings of a forward collision-avoidance assist (FCA) function of a host vehicle,
collect data for determining a sensitivity operation level of the FCA function,
determine the sensitivity operation level of the FCA function based on the collected data, and
execute sensitivity operation level adjustment for the FCA function.

12. The vehicle controller according to claim 11, wherein the non-transitory computer-readable recording medium further stores computer-readable instructions that, when executed by the one or more processors, cause the one or more processors to execute an additional safety performance improvement driving of the host vehicle during execution of the sensitivity operation level adjustment.

13. The vehicle controller according to claim 11, wherein the computer-readable instructions, when executed by the one or more processor, cause the one or more processors to collect the data by
collecting data on a traffic congested section and a road condition,
obtaining relative data with respect to front and side vehicles, and
obtaining data on the host vehicle being driven by a driver.

14. The vehicle controller according to claim 13, wherein the non-transitory computer-readable recording medium further stores computer-readable instructions that, when executed by the one or more processors, cause the one or more processors to determine whether to activate sensitivity operation adjustment logic based on determining whether a value of Y is 1 or more under an OR condition for each piece of data of X1, X2, and X3, wherein Y is determined according to
Y=(X1×k1)+(X2×k2)+(X3×k3),
wherein X1 denotes data collected from the traffic congested section and the road condition, X2 denotes relative data obtained for the front and side vehicles, and X3 denotes data obtained in the host vehicle driven by the driver.

15. The vehicle controller according to claim 14, wherein the relative data X2 is obtained according to
X2=(a×m1)+(b×m2)+(c×m3),
wherein a represents a number of times that a forward vehicle reaches a distance criterion, b represents a number of times that a relative distance criterion with respect to a side vehicle to overtake is reached, c represents a number of times that the forward vehicle reaches a TTC criterion, and each of m1, m2, and m3 is a constant.

16. The vehicle controller according to claim 14, wherein X3 is obtained according to
X3=(d×n1)+(e×n2)+(f×n3)+(g×n4),
wherein d represents a number of times that a longitudinal acceleration change criterion is reached, e represents a number of times that an APS change criterion is reached, f represents a number of times that a steering angle change amount criterion is reached, g represents whether a predetermined driving mode is in effect, and n1, n2, n3, and n4 are constants.

17. The vehicle controller according to claim 11, wherein the computer-readable instructions, when executed by the one or more processors, cause the one or more processors to execute sensitivity operation level adjustment for the FCA function by performing at least one of displaying a modal dialog indicating whether to operate FCA desensitization logic on a cluster of the host vehicle, executing sensitive warning prevention and safety performance enhancement logic, or changing a braking pressure of an electronic stability controller (ESC).

18. The vehicle controller according to claim 12, wherein the computer-readable instructions, when executed by the one or more processors, cause the one or more processors to perform the additional safety performance improvement driving by at least one of performing additional safety performance improvement logic or changing a braking pressure of an electronic stability controller (ESC) to a predetermined braking pressure.

19. The vehicle controller according to claim 11, wherein the non-transitory computer-readable recording medium: further stores computer-readable instructions that, when executed by the one or more processors, cause the one or more processors to:
determine whether to activate sensitivity operation adjustment logic; and
correct the collected data when the sensitivity operation adjustment logic activation is in a failure mode.
